(19) United States
(12) Patent Application Publication
(10) Pub. No.: US 2018/0268651 A1
(43) Pub. Date: Sep. 20, 2018

(54) PRE-PAID CASINO-PLAYERS' SYSTEM

(71) Applicant: Shawntia L. Jones, Southfield, MI (US)

(72) Inventor: Shawntia L. Jones, Southfield, MI (US)

(21) Appl. No.: 15/932,564

(22) Filed: Mar. 15, 2018

Related U.S. Application Data
(60) Provisional application No. 62/601,193, filed on Mar. 15, 2017.

(51) Int. Cl. G07F 17/32

(52) U.S. Cl. CPC G07F 17/3251; G07F 17/3239; G07F 17/3246

(57) ABSTRACT

A pre-paid casino-players' system includes providing a card of a casino to a player thereof and on which is credited a desired prepaid amount of negotiable currency; providing a personal-identification number (PIN) exclusive to the card and associating the player and card with each other; permitting the player to purchase goods and services directly from the casino and any third-party vendors located on and off premises of the casino via a transaction using the card and PIN, whereby a price of the purchase is debited from a sum remaining on the prepaid amount on the card; and permitting further negotiable currency to be added to the sum remaining on the prepaid amount on the card.

### CROSS-REFERENCE TO RELATED APPLICATION

This application is based upon and claims benefit of the filing date of U.S. Provisional Patent Application 62/601,193 filed on Mar. 15, 2017 and entitled “(Casino) Prepaid Players Card.”

### BACKGROUND OF INVENTION

### 1. Field of Invention

The invention relates, generally, to a pre-paid system for use by players of a casino and, more particularly, to a pre-paid card that can be used by such players to purchase goods and services via cashless, debit transactions at the casino or third-party vendors located on or off the premises of the casino.

### 2. Description of Related Technology

Entertainment districts often include casinos, concert halls, malls, restaurants, retail merchandise stores, sporting venues, etc. in close proximity to one another. These places offer a large variety of entertainment activities and options. People visit casinos to gamble there in hopes of winning expendable money that can be used to enhance their entertainment activities and options at the other places. For example, when a player at a casino wins money from her/his playing there a game of chance (such as a slot machine, poker, keno, or blackjack), s/he may purchase with such winnings items from a nearby retail clothing store that s/he would not normally purchase.

A casino tries to find ways to incentivize its customers, patrons, or players to play and continuing playing games at the casino and return there to play them at a later time. One such way is via use of a “credit” system of non-negotiable casino-determined entertainment credits, such as casino chips and tokens. More specifically, the casino requires each of its players to play games there with these credits. When the player wins games, winnings are in the form of these credits, which have no value and cannot be used for purchases outside the casino. As such, to purchase outside the casino with the winnings, the player is required to “cash out” to convert the credits into currency (i.e., paper money).

This “cash out” requirement can be problematic for the player who may not wish to carry cash on herself/himself for security reasons, especially when the winnings are large. Also, the “cash out” requirement forces the player to stop playing the games to convert the winnings into money. In this way, the player may convert all her/his winnings into money, which eliminates all the player's credits. When the player leaves the casino to make a purchase outside the casino and returns to the casino to gamble again, the player must obtain more credits. This can be a hassle for the player, which can result in her/his decreased interest in gaming at the casino. As such, it would be beneficial if value of the credits were honored at places other than the casino.

Toward that end, another way the casino tries to so incentivize its players is via use of a “voucher” system. More specifically, on the premises of the casino can be located, say, a third-party retail vendor like the clothing store referred to above. With the “voucher” system, the casino may present a complimentary voucher (hereinafter referred to merely as “comp”) to one of its players for him/her to use to play a game or games at the casino or purchase merchandise at the clothing store. Alternatively, the player can play a game that may result in winnings for the player in the form of a voucher that the player may use at the casino and/or clothing store. The voucher can be generated from an entirety or a portion of the winnings.

Anyway, unlike the non-negotiable credits of the “credit” system described above, the voucher is negotiable, and the player can redeem it at the casino or clothing store and re-use the voucher at the casino or clothing store until s/he exhausts the quantity of funds associated with the voucher. As an alternative, the voucher can be limited to a specific number of uses at the casino or clothing store. For instance, the voucher can be a “one-time use” voucher, which can be valid for only a single purchase at the casino or clothing store.

Either way, information about the voucher can be stored in a data store that the casino or clothing store can use to validate the voucher at time of a purchase by the player from the casino or clothing store. When the player presents the voucher to the casino or clothing store, the casino or clothing store can verify the voucher and attribute funds from it to the purchase. To illustrate, the player can present the voucher to the clothing store for the purchase there of merchandise, such as a shirt. Leftover credit not required for the purchase can be presented to the player in cash (e.g., a player purchasing a ten-dollar shirt using a twenty-dollar voucher can receive ten dollars back in cash from the clothing store). In any event, the casino is obligated to pay back the clothing store for any and all amounts the player redeems at the clothing store.

Unfortunately, however, the player cannot use the “voucher” system to purchase merchandise at a third-party retail vendor located off the premises of the casino. Also, the third-party retail vendors often must wait extended periods of time for payback from the casino for any and all amounts the player redeems at the vendors. As such, it would be beneficial if value of the vouchers were honored at places located off the premises of the casino.

Toward that end, it is known to use a conversion agency—including a financial institution—to convert a quantity of non-negotiable credits of the “credit” system to a quantity of negotiable funds of the “voucher” system, wherein the conversion agency is not directly associated with the casino. In this way, the credits are converted into a voucher prior to a purchase, wherein the vendor honors the voucher and receives negotiable funds for the voucher from the conversion agency. Yet, it would be beneficial if there were no such conversion and, in turn, conversion agency involved in the purchase, thereby eliminating at least one step and entity in the process.

Thus, there is still a need in the related technology for a system that allows players of a casino to use their respective comp or winnings there to purchase goods and services via cashless, debit transactions at the casino or third-party vendors located on or off the premises of the casino. More specifically, there is a need for such a system that does not require conversion of a quantity of non-negotiable credits to a quantity of negotiable funds for such purchase and an attendant conversion agency, thereby eliminating at least one step and entity in the process. There is a need for such a system that does not require also the vendors to wait extended periods of time for payment of such purchases. There is a need for such a system that also optimally incentivizes players of the casino to play and continuing playing games at the casino and return there to play them at a later time.

### SUMMARY OF INVENTION

The invention satisfies these needs in a pre-paid casino-players' system. The system includes providing a card of a casino to a player thereof and on which is credited a desired prepaid amount of negotiable currency; providing a personal-identification number (PIN) exclusive to the card and associating the player and card with each other; permitting the player to purchase goods and services directly from the casino and any third-party vendors located on and off premises of the casino via a transaction using the card and PIN, whereby a price of the purchase is debited from a sum remaining on the prepaid amount on the card; and permitting further negotiable currency to be added to the sum remaining on the prepaid amount on the card.

The pre-paid casino-players' system of the invention allows players of a casino to use their respective comp or winnings there to purchase goods and services via cashless, debit transactions at the casino or third-party vendors located on or off the premises of the casino.

The system also does not require conversion of a quantity of non-negotiable credits to a quantity of negotiable funds for such purchase and an attendant conversion agency, thereby eliminating at least one step and entity in the process.

The system does not require also the vendors to wait extended periods of time for payment of such purchases (i.e., the vendors are paid immediately or at least within 24 hours of the purchases).

The system also optimally incentivizes players of the casino to play and continuing playing games at the casino and return there to play them at a later time.

The system also is designed to be used at any such vendor that accepts debit transactions.

The system also permits each of the players to use a same PIN for him/her to access funds from the card at the casino and vendors for all of her/his transactions.

The system also eliminates the “credit” and “voucher” systems.

A “convenience” fee may not be applied to a player's card for his/her use of the system to purchase goods and services on the premises of the casino.

A percentage or dollar-amount “convenience” fee can be applied to a player's card for his/her use of the system to purchase goods and services off the premises of the casino.

The system does not require also credit checks of the respective players to be made.

The system allows also comp or winnings of a player to be placed on the card.

The system allows also the casino not to worry about bankrupt players.

Use of the system allows the casino to save more time and, thus, money (including using less paper, ink, and labor) than does use of the “credit” and “voucher” systems.

The system also advertises the casino.

Those having ordinary skill in the related technology should readily appreciate objects, features, and advantages of the pre-paid casino-players' system of the invention as they become more understood while the subsequent detailed description of exemplary embodiments of the system are read taken in conjunction with an accompanying drawing thereof.

### BRIEF DESCRIPTION OF EACH FIGURE OF DRAWING OF INVENTION

FIG. 1 is a flow chart showing steps involved in an exemplary embodiment of a pre-paid casino-players' system of the invention; and

FIG. 2 is a schematic diagram showing elements and interactions among them involved for purchase of goods by a player of a casino directly from a third-party vendor located off premises of the casino via a transaction using a card and PIN in accordance with the exemplary embodiment of the pre-paid casino-players' system of the invention illustrated in FIG. 1.

### DETAILED DESCRIPTION OF EXEMPLARY EMBODIMENTS OF INVENTION

Referring now to the figures, throughout which like numerals are used to designate like structure, a pre-paid casino-players' system according to the invention, in various non-limiting exemplary embodiments thereof, is generally indicated at 10. It should be readily appreciated by those having ordinary skill in the related technology that the embodiments of the system 10 described in detail below and shown in the drawing can be implemented with any suitable type of casino (e.g., a brick-and-mortar or an on-line casino) found in any suitable location (e.g., a cruise ship). It should be so appreciated also that they can be implemented also with any suitable venue, such as a sports arena or stadium.

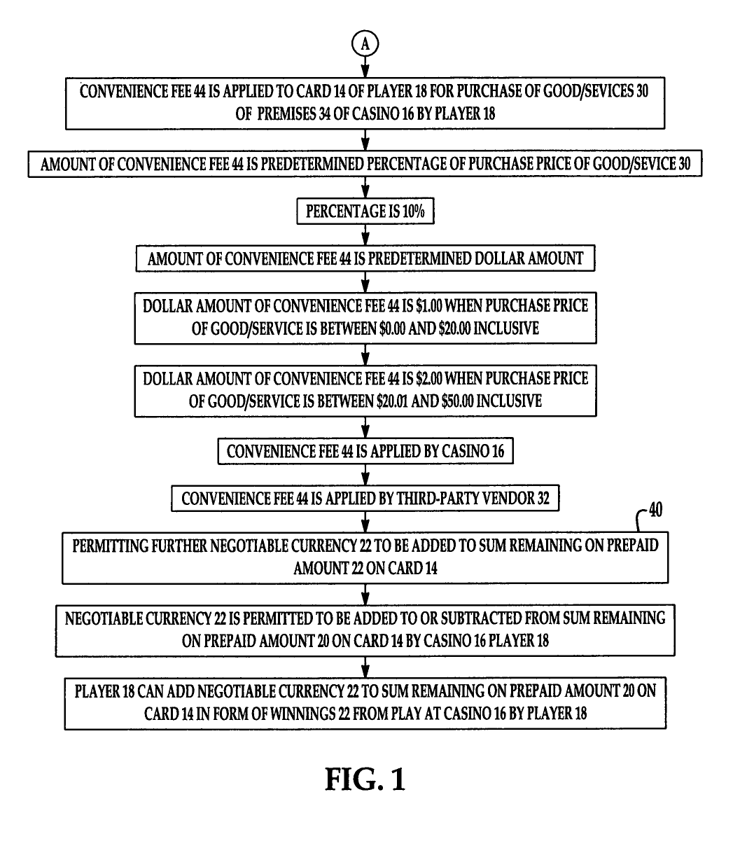

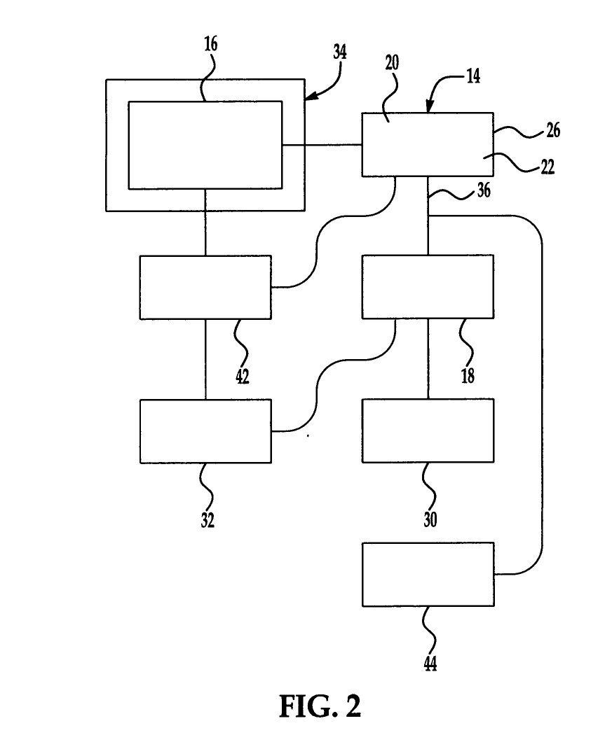

Referring now specifically to FIGS. 1-2, the system 10 includes, in general, at step 12, providing a card, generally indicated at 14, of a casino 16 to a player 18 of the casino 16 and on which is credited a desired prepaid amount of negotiable currency 20. At step 22, a personal-identification number (PIN) 24 is provided exclusive to the card 14 and associating the player 18 and card 14 with each other. At step 26, the player 18 is permitted to purchase goods and services 28 directly from the casino 16 and any third-party vendors 30 located on or off premises 32 of the casino 16 via a transaction 34 using the card 14 and PIN 24, whereby, at step 36, a price of the purchase is debited from a sum remaining on the prepaid amount 20 on the card 14. At step 38, further negotiable currency 40 is permitted to be added to the sum remaining on the prepaid amount 20 on the card 14.

More specifically and still referring to FIGS. 1-2, the card 14 is a debit card 14 issued by the casino 16, and the negotiable currency is money. The card 14 is credited the prepaid amount of money 20 by the casino 16 (i.e., as comp 20) or player 18. Thereafter, further money 40 is permitted to be added to/subtracted from the sum remaining on the prepaid amount 20 on the card 14 likewise by the casino 16 or player 18. In an embodiment of the system 10, the further money 40 can be in the form of winnings from play by the player 18 at the casino 16.

In any event, with a monetary amount associated with the card 14, the player of the casino 16 who receives the card 14 may use the monetary amount to gamble at the casino 16 and/or shop at a third-party vendor 30—including, but not limited to, a concert hall, mall, restaurant, retail merchandise store, or sporting venue—located on or off the premises 32 of the casino 16. In that regard, all relevant information about the card 14 is stored on a computer, network, server, or other system 42 configured to permit the casino 16 and third-party vendor 30 to have access to the information, share it with each other, and use it to communicate with each other to validate the card 14 and transaction 34 at time of the purchase. In other words, when the player 18 presents the card for the purchase, the card 14 and transaction 34 are verified, and funds are attributed from the card 14 to the purchase.

It should be readily appreciated by those having ordinary skill in the related technology that the card 14 can have any suitable color scheme, design, shape, size, and structure. For instance, in an embodiment of the system 10, information identifying the casino 16 can be displayed upon the card 14 as advertising for the casino 16. It should be so appreciated also that any suitable prepaid amount of money can be credited to the card 14, and any suitable further amount of money can be added to or subtracted from the sum remaining on the prepaid amount 20 on the card 14. It should be so appreciated also that the money can be U.S. or foreign currency, depending, of course, upon the country or region where the casino 16 and third-party vendor(s) 30 are located. It should be so appreciated also that the third-party vendor 30 can be any suitable type of vendor. It should be so appreciated also that the casino 16 and third-party vendor 30 can communicate with each other in any suitable manner to validate the card 14 and transaction 34 at the time of the purchase.

If the player 18 provides the funds associated with the card 14, the player 18 may simply cash out any funds remaining on the card 14 at the end of a gaming and/or shopping session. Alternatively, the player 18 can simply leave any funds remaining on the card 14 at the end of a gaming and/or shopping session for use by the player 18 at a future gaming and/or shopping session at the casino 16. However, if the casino 16 provides the funds associated with the card 14, the casino 16 may not allow the funds associated with the card 14 to be cashed out. In that case, the player 18 may simply have to use up the funds associated with the card 14 in a single gambling and/or shopping session or lose them. Alternatively, the casino 16 may allow any funds remaining on the card 14 at the end of a gaming and/or shopping session to be used by the player 18 at a future gaming and/or shopping session at the casino 16.

The same card 14 and PIN 24 are used for every transaction 34. In this way, the player 18 uses the same card 14 and PIN 24 for every game s/he plays at the casino 16 and every purchase s/he makes from a third-party vendor 30 on or off the premises 32 of the casino 16. It should be readily appreciated by those having ordinary skill in the related technology that the PIN 24 can be assigned by the casino 16 or selected by the player 18. It should be so appreciated also that the PIN 24 can be any suitable type—say, alphanumeric—and any suitable length.

In an embodiment of the system 10, no “convenience” fee 44 is applied by the casino 16 or third-party vendor 30 to the card 14 of the player 18 for his/her purchase of goods and/or services 28 on the premises 32 of the casino 16. In contrast, in another embodiment, a “convenience” fee 44 is applied by the casino 16 to the card 14 of the player 18 for his/her purchase of goods and/or services 28 off the premises 32 of the casino 16. In an aspect of this embodiment, the amount of the “convenience” fee 44 is a predetermined percentage of the total purchase price (net any sales taxes) of the good(s) and/or service(s) 28. By way of example only and not by way of limitation, the percentage can be 10% such that a “convenience” fee 44 of, say, $5.00 is applied by the casino 16 to the card 14 of the player 18 for his/her purchase of fifty-dollars worth of merchandise 28 off the premises 32 of the casino 16.

In yet another embodiment of the system 10, the amount of the “convenience” fee 44 is a predetermined dollar amount. By way of example only and not by way of limitation, the dollar amount of the “convenience” fee 44 can be based upon a tiered system. Toward that end, the “convenience” fee 44 can be, say, $1.00 when the total purchase price (net any sales taxes) of the good(s) and/or service(s) 28 is between $0.00 and $20.00 (inclusive) . . . and the dollar amount of the “convenience” fee 44 can be, say, $2.00 when the total purchase price (net any sales taxes) of the good(s) and/or service(s) 28 is between $20.01 and $50.00 (inclusive).

It should be readily appreciated by those having ordinary skill in the related technology that the “convenience” fee 44 can be applied by the third-party vendor 30 alone or both the casino 16 and third-party vendor 30. It should be so appreciated also that, in the latter case, the casino 16 and third-party vendor 30 can split the “convenience” fee 44 any suitable way. It should be so appreciated also that a “convenience” fee 44 can be applied to the card 14 of the player 18 for his/her purchase of goods and/or services 28 on the premises 32 of the casino 16. It should be so appreciated also that the “convenience” fee 44 can be any suitable amount and calculated by use of any suitable method.

The system 10 allows players 18 of a casino 16 to use their respective comp 20 or winnings there to purchase goods and services 28 via cashless, debit transactions 34 at the casino 16 or third-party vendors 30 located on or off the premises 32 of the casino 16. Also, the system 10 does not require conversion of a quantity of non-negotiable credits to a quantity of negotiable funds for such purchase and an attendant conversion agency, thereby eliminating at least one step and entity in the process. Furthermore, the system 10 does not require these vendors 30 to wait extended periods of time for payment of such purchases (i.e., the vendors 30 are paid immediately or at least within 24 hours of the purchases). In addition, the system 10 optimally incentivizes players 18 of the casino 16 to play and continuing playing games at the casino 16 and return there to play them at a later time. Moreover, the system 10 is designed to be used at any such vendor 30 that accepts debit transactions 34. Plus, the system 10 permits each of the players 18 to use a same PIN 24 for him/her to access funds from the card 14 at the casino 16 and vendors 30 for all of her/his transactions. The system 10 eliminates the “credit” and “voucher” systems as well.

A “convenience” fee 44 may not be applied to a card 14 of the player 18 for his/her use of the system 10 to purchase goods and services 28 on the premises 32 of the casino 16. (Rather, a percentage or dollar-amount “convenience” fee 44 can be applied to the card 14 for his/her use of the system 10 to purchase goods and services 28 off the premises 32 of the casino 16.) Also, the system 10 does not require credit checks of the respective players 18 to be made. Furthermore, the system 10 allows comp or winnings of a player 18 to be placed on the card 14: In addition, the system 10 allows the casino 16 not to worry about bankrupt players 18. Moreover, use of the system 10 allows the casino 16 to save more time and, thus, money (including using less paper, ink, and labor) than does use of the “credit” and “voucher” systems. Plus, the system 10 advertises the casino 16.

The system 10 has been described above in an illustrative manner. Those having ordinary skill in the related technology should readily appreciate that the terminology that has been used above is intended to be in the nature of words of description rather than of limitation. Many modifications and variations of the system 10 are possible in light of the above teachings. Therefore, within the scope of the claims appended hereto, the system 10 may be practiced other than as so described.

What is claimed is:

1. A pre-paid casino-players' system comprising:
providing a card of a casino to a player thereof and on which is credited a desired prepaid amount of negotiable currency;
providing a personal-identification number (PIN) exclusive to the card and associating the player and card with each other;
permitting the player to purchase goods and services directly from the casino and any third-party vendors located on and off premises of the casino via a transaction using the card and PIN, whereby a price of the purchase is debited from a sum remaining on the prepaid amount on the card; and
permitting further negotiable currency to be added to the sum remaining on the prepaid amount on the card.

2. The pre-paid casino-players' system as set forth in claim 1, wherein the card is a debit card.

3. The pre-paid casino-players' system as set forth in claim 1, wherein the card is issued by the casino.

4. The pre-paid casino-players' system as set forth in claim 1, wherein the negotiable currency is money.

5. The pre-paid casino-players' system as set forth in claim 1, wherein the card is credited the prepaid amount of negotiable currency by either of the casino and player.

6. The pre-paid casino-players' system as set forth in claim 1, wherein the negotiable currency is permitted to be either of added to and subtracted from the sum remaining on the prepaid amount on the card by either of the casino and player.

7. The pre-paid casino-players' system as set forth in claim 6, wherein the player can add the negotiable currency to the sum remaining on the prepaid amount on the card in form of winnings from play at the casino by the player.

8. The pre-paid casino-players' system as set forth in claim 1, wherein the third-party vendor includes any of a concert hall, mall, restaurant, retail merchandise store, and sporting venue.

9. The pre-paid casino-players' system as set forth in claim 1, wherein all relevant information about the card is stored on any of a computer, network, server, and system configured to permit the casino and third-party vendor to have access to the information, share it with each other, and use it to communicate with each other to validate the card and transaction at time of the purchase.

10. The pre-paid casino-players' system as set forth in claim 1, wherein information identifying the casino is displayed upon the card as advertising for the casino.

11. The pre-paid casino-players' system as set forth in claim 1, wherein the same card and PIN are used for every transaction.

12. The pre-paid casino-players' system as set forth in claim 1, wherein no convenience fee is applied to the card of the player for purchase of goods and services on the premises of the casino by the player.

13. The pre-paid casino-players' system as set forth in claim 1, wherein a convenience fee is applied to the card of the player for purchase of goods and services off the premises of the casino by the player.

14. The pre-paid casino-players' system as set forth in claim 13, wherein an amount of the convenience fee is a predetermined percentage of the purchase price of either of the good and service.

15. The pre-paid casino-players' system as set forth in claim 14, wherein the percentage is 10%.

16. The pre-paid casino-players' system as set forth in claim 13, wherein an amount of the convenience fee is a predetermined dollar amount.

17. The pre-paid casino-players' system as set forth in claim 16, wherein the dollar amount of the convenience fee is $1.00 when the purchase price of either of the good and service is between $0.00 and $20.00 inclusive.

18. The pre-paid casino-players' system as set forth in claim 16, wherein the dollar amount of the convenience fee is $2.00 when the purchase price of either of the good and service is between $20.01 and $50.00 inclusive.

19. The pre-paid casino-players' system as set forth in claim 13, wherein the convenience fee is applied by the casino.

20. The pre-paid casino-players' system as set forth in claim 13, wherein the convenience fee is applied by the third-party vendor.
